(19) United States
(12) Patent Application Publication
(10) Pub. No.: US 2007/0254757 A1
(43) Pub. Date: Nov. 1, 2007

(54) Compression roller for an exercise apparatus with a crank transmission unit

(76) Inventor: Leao Wang, Taiping (TW)

Correspondence Address: KUO-HSIUNG CHIU, 13F., NO.23, JIUN-HO STREET, PEITUN DISTRICT, TAICHUNG, 406, TW

(21) Appl. No.: 11/410,877

(22) Filed: Apr. 26, 2006

(51) Int. Cl. F16H 7/12; F16H 7/14

(52) U.S. Cl. 474/138; 474/133; 474/117

(57) ABSTRACT

A compression roller for an exercise apparatus with a crank transmission unit comprising a spring leaf with high elasticity being fixed at one end abutting to a transmission belt. A compression roller opposing to the transmission belt is rotatably disposed at a free end of the spring leaf. Accordingly, the compression roller is constantly and continuously compressed by the spring force of the spring leaf against the transmission belt in a tight state.

### BACKGROUND OF THE INVENTION

1. Fields of the Invention

The invention relates to a compression roller for an exercise apparatus with a crank transmission unit, and more particularly to a compression roller having a simple configuration, low fabrication cost and an excellent compression effect as well as easy to fabricate and assemble.

2. Description of the Related Art

As shown in FIG. 2, an exercise apparatus with a crank transmission unit includes a crank 10 that imparts rotation to a big toothed wheel 11 while a small toothed wheel 13 is brought into rotation via a transmission belt 12. Thereafter, the small toothed wheel 13 will unidirectionally drive a flywheel 14 into an inertia rotation. In this way, a basic power transmission mode is created. This has been well-known and widely applied to specific exercisers with treading motion like fitness bikes, elliptic cross trainers, etc.

During the exercise session, the crank 10 can be treaded by the operator with different force, thereby making the transmission belt 12 in sometimes tight and sometimes loose state. Therefore, an undesired vibration of the transmission belt 12 will arise. Meanwhile, the transmission belt 12 can sag after use for a longer period, thereby increasing the vibration of the transmission belt 12. Accordingly, the operator will have an unpleasant feeling when the transmission belt 12 is in an idle state. In order to improve this problem, a fixed type compression roller 15 is installed in close vicinity to the transmission belt 12 for being in constant contact with the transmission belt 12. In this way, the assembly tolerance of the transmission belt 12 can be considerably reduced beforehand. Meanwhile, a counteracting effect will be created against an abnormal treading action so as to effectively reduce the degree of vibration.

During the initial use of the compression roller 15, it can fulfill its function. However, as previously stated, the transmission belt 12 will sag after use for a longer period. Moreover, the compression roller 15 shows wear when it is subjected to continuous friction. As a result, an unbearable vibration could still arise after a longer period.

### SUMMARY OF THE INVENTION

In view of the aforementioned drawbacks, the inventor tried to employ a non-fixed type compression roller in cooperation with a spring leaf having a strong elasticity for a constant compression against a transmission belt. Even when the transmission belt shows sag or the compression roller 15 shows wear, the resilient force of the spring leaf can be employed to remove the potential vibration action. Meanwhile, the invention has merits of simple configuration, low cost, easy fabrication and assembly, thereby considerably increasing the practicalness and convenience thereof. These are main objects of the invention.

According to the invention, a compression roller for an exercise apparatus with a crank transmission unit includes a spring leaf with high elasticity being fixed at one end abutting to a transmission belt. A compression roller opposing to the transmission belt is rotatably disposed at a free end of the spring leaf. Accordingly, the compression roller is constantly and continuously compressed by the spring force of the spring leaf against the transmission belt in a tight state.

### BRIEF DESCRIPTION OF THE DRAWINGS

The accomplishment of this and other objects of the invention will become apparent from the following description and its accompanying drawings of which:

FIG. 1 is a schematic drawing of a preferred embodiment of the invention; and

FIG. 2 is a schematic drawing of a conventional crank transmission unit.

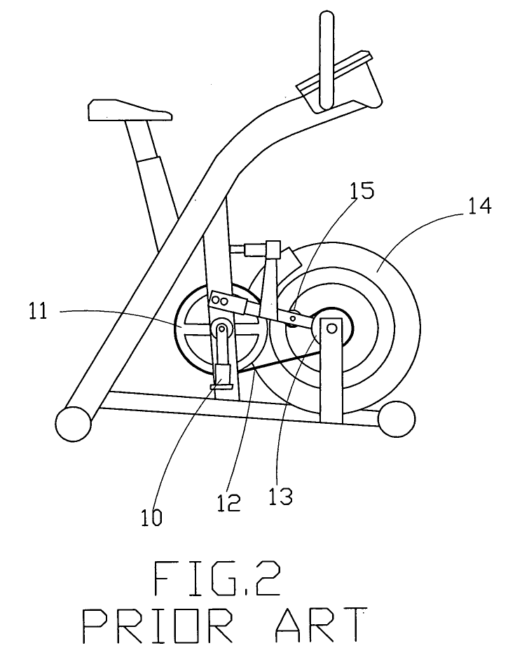

### DETAILED DESCRIPTION OF THE PREFERRED EMBODIMENT

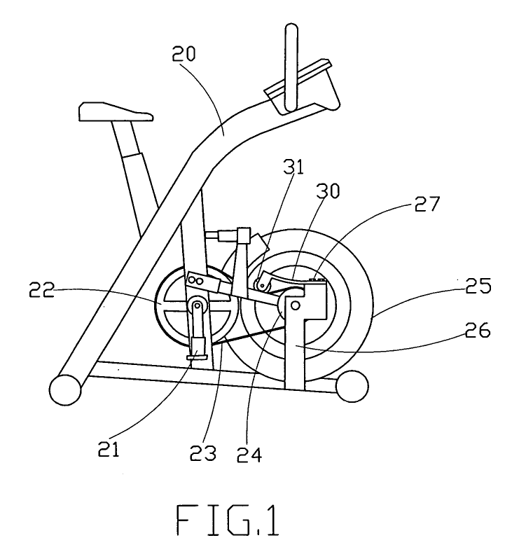

First of all, referring to FIG. 1, a compression roller in accordance with the invention is applied to a fitness bike 20. The fitness bike 20 includes a crank 21 that imparts rotation to a big toothed wheel 22 while a small toothed wheel 24 is brought into rotation via a transmission belt 23. Thereafter, the small toothed wheel 24 will unidirectionally drive a flywheel 25 into an inertia rotation. A spring leaf 30 with high elasticity is fixed by a fastening element 27 on the top of a bear frame 26 for the small toothed wheel 24. A compression roller 31 opposing to the transmission belt 23is rotatably disposed at a free end of the spring leaf 30. The compression roller 31 is directly and constantly compressed against the transmission belt 23 while the spring leaf 30 is slightly bent under application of force.

Based on the above-mentioned configuration, the spring leaf 30 and the compression roller 31 can adjust themselves to the force acting on the transmission belt 23 and constantly be in contact with the transmission belt 23 to keep it in a tight state.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claim.

What is claimed is:

1. A compression roller for an exercise apparatus with a crank transmission unit comprising a spring leaf with high elasticity being fixed at one end abutting to a transmission belt, a compression roller opposing to the transmission belt being rotatably disposed at a free end of the spring leaf,
whereby the compression roller is constantly and continuously compressed by the spring force of the spring leaf against the transmission belt in a tight state.
